(19) United States
(12) Patent Application Publication
(10) Pub. No.: US 2016/0225003 A1
(43) Pub. Date: Aug. 4, 2016

(54) SYSTEMS FOR GENERATING ACTIONABLE RECOMMENDATION OBJECTS BASED ON GEOGRAPHIC AND SALES LOYALTIES

(71) Applicant: GM GLOBAL TECHNOLOGY OPERATIONS LLC, Detroit, MI (US)

(72) Inventors: ROBERT R. INMAN, ROCHESTER HILLS, MI (US); MICHAEL S. HARBAUGH, CLARKSTON, MI (US)

(73) Assignee: GM GLOBAL TECHNOLOGY OPERATIONS LLC

(21) Appl. No.: 14/833,230

(22) Filed: Aug. 24, 2015

Related U.S. Application Data
(63) Continuation-in-part of application No. 14/632,232, filed on Feb. 26, 2015.
Application No. 14/632,232 is a continuation-in-part of application No. 14/618,351, filed on Feb. 10, 2015.
Application No. 14/618,351 is a continuation-in-part of application No. 14/612,711, filed on Feb. 3, 2015.

(51) Int. Cl. G06Q 30/02

(52) U.S. Cl. CPC G06Q 30/0205

(57) ABSTRACT

The present technology relates to systems and processes for evaluating and comparing dealers of products such as automobiles with consideration to objective measures of prior-sale and geography-based loyalty. The system is configured to determine on or more actionable sales-improvement objects for use in improving dealer performance in terms of prior-sale and geography-based loyalty. The system is configured to transmit the performance-improvement object to a receiving device for use in improving sales-and-geographic loyalty performance of the dealer.

### TECHNICAL FIELD

The present disclosure relates generally to systems for providing actionable guidance for sellers of a product and, more particularly, to systems generating actionable recommendation objects based on seller performance evaluated with respect to prior-sales and customer-geography data.

### BACKGROUND

No matter the product, numerous factors usually control purchasing decisions. For example, numerous factors can affect a buyer's selection of a dealership from which to purchase a new or replacement vehicle, such as an automobile.

It can thus be difficult to accurately and fairly evaluate a seller's performance and, especially, compare performances of two or more sellers. A buyer may purchase a replacement vehicle from a certain seller based on proximity of a seller's storefront to the buyer's residence, for instance, or have loyalty to the seller from which they purchased their previous vehicle. Assessing the effects of such factors on purchasing practices has remained a challenge.

### SUMMARY

There is a need for a system that can accurately and fairly evaluate a subject seller, and compare sellers of products, such as automobiles.

The entities evaluated, ranked, advised, and modified by operation of the present technology are, generally, entities that sell or provide a product or a service. While the technology is described primarily herein in connection with sales of products, such as automobiles, the technology can be used in any of a wide variety of implementations in which a product or service is sold or provided. The technology can be used to evaluate service providers, even if they do not sell the services, for instance, such as government entities (e.g., department of motor vehicle offices, charter schools, or community colleges) or religious organizations (e.g., churches or religious schools).

The entities can be referred to by a variety of terms, such as seller, dealer, provider, retailer, the like, or other. The term dealer is used primarily herein in a non-limiting sense. The term dealership is also used at times, especially in connection with exemplary automotive or other vehicle scenarios, but again these uses too should be interpreted broadly, such as to accommodate other product and service scenarios.

The system is configured in various ways to accomplish these goals with consideration to objective measures of prior-sale loyalty and geography-based loyalty. In one implementation, the system is configured to determine one or more actionable sales-improvement objects.

The system comprises a processing hardware unit and a non-transitory storage device comprising instructions that, when executed by the hardware unit, cause the unit to perform various operations. The operations comprise evaluating geographic and sales loyalties of an individual dealer. Operations also include comparing dealers based on their loyalties, comprising generating, in connection with a first dealer and a second dealer.

Customers having a connection to both dealers, one by geography and one by prior sale, are said to be shared customers. A customer who purchased their prior vehicle from the first dealer (X) but now lives in the area of the second dealer (Y), would be considered a shared customer, for example. Shared customers also similarly include those who purchased from the second dealer and who live in or moved to the first-dealer area.

The operations in various embodiments further comprise generating, in response to determining that the first dealer is the best dealer of the pair, an output object, such as an object comprising an improvement recommendation, for use by a low performing dealer of a group of dealers compared. The output object can include a controllable factor contributing more than other controllable factors to the low performance.

Other aspects of the present technology will be in part apparent and in part pointed out hereinafter.

### DESCRIPTION OF THE DRAWINGS

FIG. 1 illustrates schematically a system including a processing hardware unit and a non-transitory storage device, according to an embodiment of the present disclosure.

FIG. 2 illustrates by flow chart a process for comparing geographic- and sales-loyalty values, of multiple dealers, according to an embodiment of the present disclosure.

FIG. 3 illustrates a process for determining a performance-improvement object for at least one of the dealers evaluated.

FIG. 4 illustrates a process for determining an output object for use in improving sales-loyalty performance for one or more dealers.

FIG. 5 illustrates a process of determining relevant latent factors for improving dealer performance and performance-evaluation models.

FIG. 6 illustrates a process for determining target sales-loyalty values based on a plurality of uncontrollable factors.

FIG. 7 illustrates a process for determining target sales-loyalty values based on a plurality of controllable factors and uncontrollable factors.

FIG. 8 illustrates methods for evaluating sales loyalty of a subject dealer and comparing one or more dealers based on sales-loyalty.

FIG. 9 illustrates an example sales-loyalty chart indicating actual performance levels and respective benchmarks in connection with four performance segments.

The figures are not necessarily to scale and some features may be exaggerated or minimized, such as to show details of particular components. In some instances, well-known components, systems, materials or processes have not been described in detail in order to avoid obscuring the present disclosure.

Therefore, specific structural and functional details disclosed herein are not to be interpreted as limiting, but merely as a basis for the claims and as a representative basis for teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

While the present technology is described primarily herein in connection with automobile dealers that sell automobiles, the technology is not limited to automobile dealers. The concepts can be used in a wide variety of applications, such as in connection with sellers or providers or aircraft, marine craft, non-vehicle products, food, or services, or other, for instance. The sellers or providers could thus include automobile dealerships, other vehicle dealers, retail or department stores, government entities, religious institutions, restaurants, the like, and other.

The present disclosure describes 1) systems configured to generate and use metrics for pairwise comparison of dealer sales performance and 2) an object to enable dealers to take effective improvement actions. The object can be used to identify improvement opportunities for individual dealers.

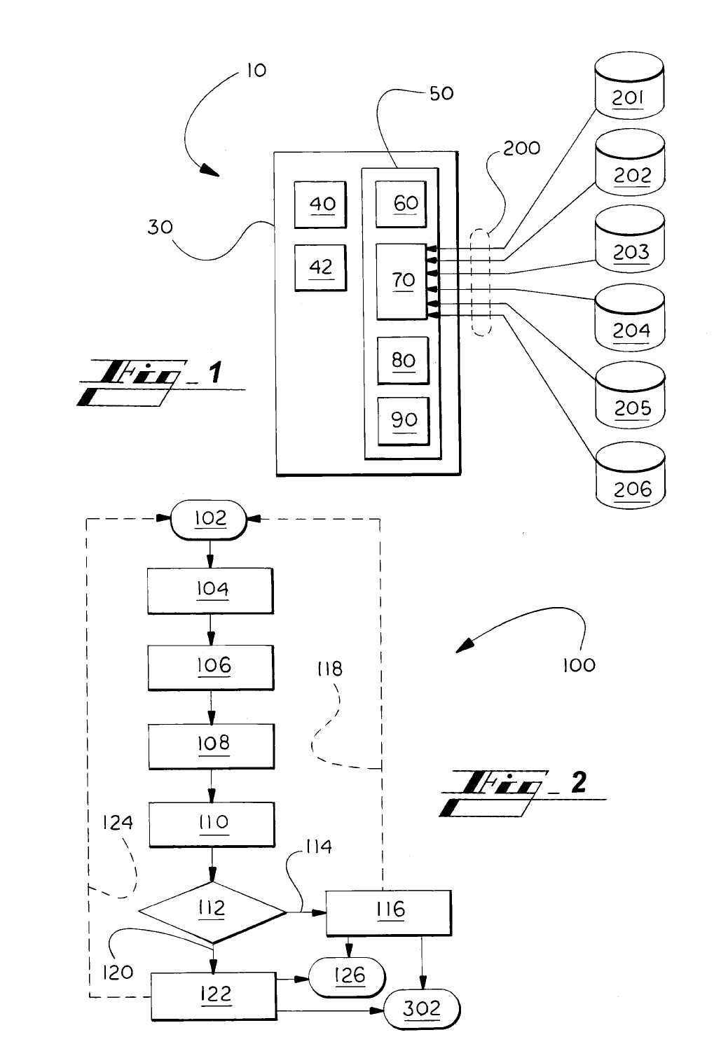

### FIG. 1—System and Computing Structures

FIG. 1

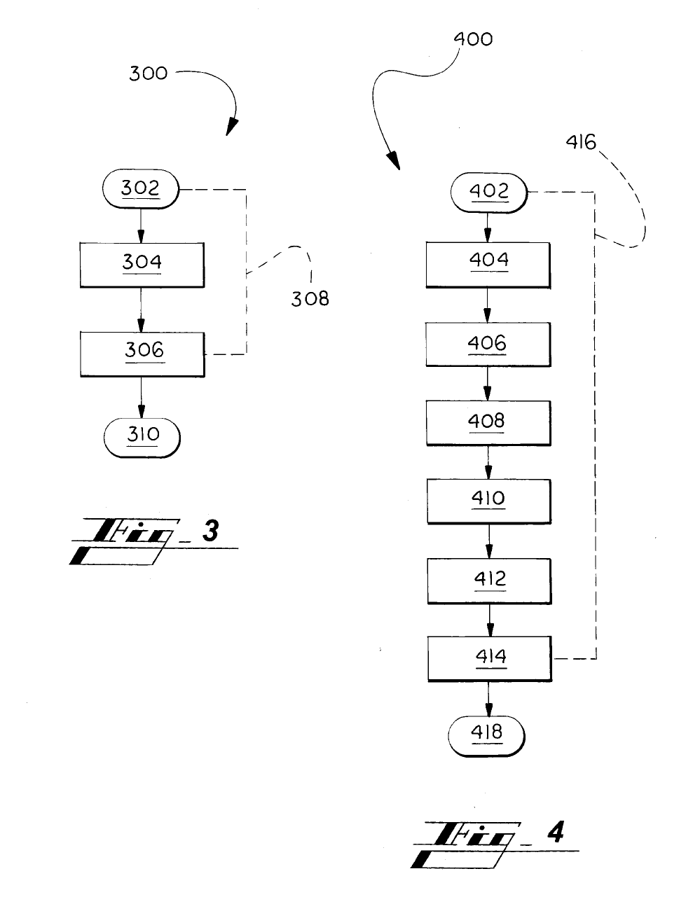

A system 10 shown in FIG. 1 is configured to perform a process 100 illustrated in FIG. 2. The system 10 includes a computing apparatus 30. The computing apparatus 30 comprises a processing hardware unit 40 for processing, generating, and controlling data. The apparatus 30 also includes input/output data ports 42, and a non-transitory computer-readable storage device 50. Connecting infrastructure within the system 10, such as one or more data buses and wireless transceivers, is not shown in detail to simplify the figures.

The processing hardware unit 40 includes one or multiple processors, which could include distributed processors or parallel processors in a single machine or multiple machines. The processing hardware unit could include virtual processor(s). The processing hardware unit could include a state machine, application specific integrated circuit (ASIC), programmable gate array (PGA) including a Field PGA, or state machine. When the processing hardware unit executes instructions to perform operations, this could include the processing hardware unit performing the operations directly and/or facilitating, directing, or cooperating with another device or component to perform the operations.

The non-transitory computer-readable storage device 50 can include a variety of computer-readable media, including volatile media, non-volatile media, removable media, and non-removable media. The term “computer-readable media” and variants thereof, as used in the specification and claims, includes storage media. Storage media includes volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that is configured to be used to store information that can be accessed by the computing apparatus 30.

While the non-transitory computer-readable storage device 50 is illustrated as residing proximate the processing hardware unit 40, it should be understood that at least a portion of the memory can be a remotely accessed storage system, for example, a server on a communication network, a remote hard disk drive, a removable storage medium, combinations thereof, and the like. Thus, any of the data, applications, and/or software described below can be stored within the memory and/or accessed via network connections to other data processing systems (not shown) that may include a local area network (LAN), a metropolitan area network (MAN), or a wide area network (WAN), for example.

The non-transitory computer-readable storage device 50 includes several categories of software and data used in the computing apparatus 30 including applications 60, a database 70, an operating system 80, and input/output device drivers 90.

As will be appreciated by those skilled in the art, the operating system 80 may be any operating system for use with a data processing system. The input/output device drivers 90 may include various routines accessed through the operating system 80 by the applications to communicate with devices, and certain memory components. The applications 60 can be stored in the non-transitory computer-readable storage device 50 and/or in a firmware (not shown) as executable instructions, and can be executed by the processing hardware unit 40.

The applications 60 include various programs that, when executed by the processing hardware unit 40, cause the processing hardware unit to implement the various features of the computing apparatus 30. The applications 60 include applications described in further detail with respect to exemplary processes. The applications 60 are stored in the non-transitory computer-readable storage device 50 and are configured to be executed by the processing hardware unit 40.

The term application, or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

Modules can be named according to the function(s) that the software within them cause a processor to perform. A module causing a processor to perform a function of generating an output object could be referred to as a generating module, an output-object generating module, or similar.

The applications 60 may use data stored in the database 70. The database 70 includes static and/or dynamic data used by the applications 60, the operating system 80, the input/output device drivers 90 and other software programs that may reside in the non-transitory computer-readable storage device 50.

Other features shown in FIG. 1 are described further below in connection with the process of FIG. 2, including the two-hundred series structures shown (200, 201, etc.).

It should be understood that FIG. 1 and the description above are intended to provide a brief, general description of a suitable environment in which the various aspects of some embodiments of the present disclosure can be implemented. While the description refers to computer-readable instructions, embodiments of the present disclosure also can be implemented in combination with other program modules and/or as a combination of hardware and software in addition to, or instead of, computer readable instructions.

Any of the components used in performance of functions of the present technology can be provisioned or positioned at a remote computer, server, computing center, or other, such as by cloud computing.

### FIGS. 2-9—Processes of Operation

FIGS. 2-7 show exemplary algorithms in the form of processes that facilitate analyzing and improving dealer sales performance, according to embodiments of the present disclosure. FIG. 9 illustrates an example performance-evaluation chart, comprising target benchmarks, referenced in the processes of FIGS. 2-8.

The processes are performed by one or more hardware units, like the apparatus 30 of FIG. 1. The performing hardware may include one or more units operated and maintained by an automotive manufacturer, one or more dealerships, or an entity having as a primary function analyzing and reporting on performance data (e.g., auto sales performance) as a primary function of operation. These performers can be referred to generally as service providers.

Portions of the processes or algorithms presented may be referred herein to by a variety of terms, such as operations, functions, routines, blocks, decision diamonds, flow paths, or the like. It should be understood that the operation, functions or steps of the algorithms, or processes, are not necessarily presented in any particular order and that performance of some or all the steps in an alternative order is possible and is contemplated. The operations have been presented in the demonstrated order for ease of description and illustration. Operations can be added, omitted and/or performed simultaneously without departing from the scope of the appended claims.

It should also be understood that the illustrated processes can be ended at any time. In certain embodiments, some or all steps of this process, and/or substantially equivalent steps are performed by execution of instructions stored or included on a computer-readable medium, such as the non-transitory computer-readable storage device 50 of the computing apparatus 30 described above, for example.

FIG. 2

The process 100 of FIG. 2 begins 102 and flow proceeds to operation 104 whereat the system 10—e.g., the processing hardware unit 40 executing code stored at the non-transitory computer-readable storage device 50—generates, or otherwise obtains (e.g., receives), various metrics in connection with a pair of dealers including a first dealer (X) and a second dealer (Y). The metrics relate to a number of customers having purchased a prior vehicle, and then purchased a subsequent, or replacement, vehicle.

As mentioned, owners of a product, such as an automobile, may purchase a replacement from a certain dealer based on proximity of a dealer storefront to the buyer's residence, or have loyalty to the dealer from having purchased their previous product from the dealer.

In one aspect of the present technology, three primary factors are considered for analyzing sales performance of the first dealer and the second dealer in connection with purchase of a replacement: (i) dealer from which the prior vehicle was purchased, (ii) geographical area of residence of the purchaser, and (iii) dealer from which the replacement vehicle was purchased.

Geographic areas are defined and used to determine which dealer a purchaser is near. Determining the areas can be done in any of a wide variety of ways. The areas can be defined by a producer of the product, such as an automobile manufacturer, or another service provider, for example. The service provider may divide a general region (e.g., the United States, a state, a country, etc.) into multiple geographic areas.

In various embodiments, each area is or can be referred to as an area of primary responsibility (APR) or an area of geographic sales and service advantage (AGSSA).

In one implementation, each area is dedicated to a distinct dealer. In a contemplated embodiment, one area can overlap with another area. In another contemplated embodiment, one area can include more than one dealer. In still another contemplated embodiment, at least one dealer is positioned in more than one area. Typically, but not always, dealers being compared are associated with respective areas that do not overlap.

Areas involved with a comparison can be directly adjacent to each other, by touching at one more points, or spaced apart from each other.

The areas can be determined by a manufacturer or other service provider, for example. The areas are in various embodiments determined based on population distributions, transportation time, sales distributions, governmental boundaries and/or other factors. Regarding transportation time, for instance, an area for a dealer could be transcribed by the distance that can be traveled by car from the dealer in various directions in a certain amount of time, such as an hour's drive.

At least one area is, in a contemplated implementation, based on governmental boundaries, such as those of a city, country, state, census tracts, or nation.

In various embodiments, a residence or geographic factor indicates the area in which a purchaser or receiver of a replacement product or service resides when they purchased or received the replacement product or service. In contemplated embodiments, the residence factor can indicate the area in which the purchaser or receiver resided at a different time, such as when the prior product or service, being replaced, was purchased or received.

Purchasers can be identified for the evaluations of the present technology in any of a variety of manners. The purchasers can be identified by name, social security number, or other personal indicia. In various embodiments, an account for each purchaser is associated with a product number. The purchase can be associated, for example, with a vehicle identification number (VIN), such as a VIN of a prior vehicle, that was replaced, or a VIN of a replacement vehicle.

In various embodiments, customers, or VINs, are included in the evaluation only if the prior vehicle and the replacement vehicle have the same brand, or retailer—e.g., both are vehicle made by the General Motors® company—or a subsidiary or affiliate.

Data for use in generating these factors can be obtained in any of a variety of ways. The data, or portions thereof, can be referred to as dealer sales data, comprising information pertaining to sales of prior and replacement vehicles.

For embodiments in which some or all of the data is received from one or more sources outside of the computing apparatus 30, data received is indicated schematically in FIG. 1 by reference numeral 200. The data 200 is received by way of the input/output data ports 42 mentioned above, for example, and/or any applicable input/output device drivers 90.

In one embodiment, some or all of the data used in evaluating dealers the factors is received from a database, remote to the computing apparatus 30. Reference numeral 201 in FIG. 1 indicates at least one such database. The remote database 201 is in various embodiments operated and maintained by a manufacturer or a retailer, such as a retailer of the vehicles sold by the first and second dealers. In one embodiment, the remote database 201 is operated and maintained by a third-party entity, such as a provider of vehicle sales analytics services, or a provider of data centers.

The computing apparatus 30 can communicate with separate systems, such as local and remote computers. In various embodiments the apparatus 30 is configured to communicate with such systems by wire and/or wirelessly, such as by way of a tangible, non-transitory hardware, such as wireless receiver, transmitter, or transceiver. Underlying hardware can be a part of the mentioned input/output (i/o) data ports 42, for instance, and supported by operation of the input/output device drivers 90.

In one embodiment, some or all of the data used in generating the factors is received from first and second computing systems associated respectively with the first and second dealers (X, Y). The first and second computing systems are indicated by reference numerals 202, 203, respectively, in FIG. 1.

Obtaining the data used in determining the factors (i)-(iii) for the dealers can also include generating, by the processing hardware unit 40, some or all of the data based on locally-stored information and/or information received at the computing apparatus 30.

However obtained, the resulting data used in determining values for the factors (i)-(iii) are in some embodiments stored locally, at the computing apparatus 30. In one embodiment, the data is stored remotely, such as in a server or cloud-computing arrangement.

While these factors (i)-(iii) can yield numerous combinations, in one embodiment four (4) primary combinations, or categories of customer-repurchase scenarios or segments, are considered primarily. The four (4) primary combinations can also be referred to as replacement subsets, replacement/geographic subsets, geographic-based replacement sub-sets, or the like.

Using the aforementioned convention, with the first dealer represented by X and the second dealer represented by Y, the four (4) geographic-based vehicle-replacement sub-sets (GVRSs) can be shown graphically by table, as follows:

TABLE 1

| | Prior-Vehicle | | Replacing-Vehicle |
|---|---|---|---|
| | Dealer | AGSSA | Dealer |
| 1st GVRS | Y | X | X |
| 2d GVRS | Y | X | Y |
| 3d GVRS | X | Y | Y |
| 4th GVRS | X | Y | X |

Other combinations include:

TABLE 2

| | Prior-Vehicle | | Replacing-Vehicle |
|---|---|---|---|
| | Dealer | AGSSA | Dealer |
| 5th GVRS | X | X | X |
| 6th GVRS | Y | Y | Y |
| 7th GVRS | Y | Y | X |
| 8th GVRS | X | X | Y |

The sub-sets can be viewed from the perspective of either dealer, with primary scenarios labeled a, b, c, d. The following table shows these scenarios labeled, a, b, c, d with respect to the first dealer X and the second dealer Y.

TABLE 3

| | | Prior-Vehicle | | Replacing- |
|---|---|---|---|---|
| | Scenario | Dealer | AGSSA | Vehicle Dealer |
| 1st GVRS | b_{X} | Y | X | X |
| | (geographic | | | |
| | loyalty)ₓ | | | |
| 2d GVRS | c_{Y} | Y | X | Y |
| | (prior-sale | | | |
| | loyalty)_{y} | | | |
| 3d GVRS | b_{Y} | X | Y | Y |
| | (geographic | | | |
| | loyalty)_{y} | | | |
| 4th GVRS | c_{X} | X | Y | X |
| | (prior-sale | | | |
| | loyalty)ₓ | | | |
| 5th GVRS | a_{X} | X | X | X |
| | (geography | | | |
| | and prior-sale | | | |
| | loyalties)ₓ | | | |
| 6th GVRS | a_{Y} | Y | Y | Y |
| | (geography | | | |
| | and prior-sale | | | |
| | loyalties)_{y} | | | |
| 7th GVRS | d_{X} | Y | Y | X |
| | (no loyalty)ₓ | | | |
| 8th GVRS | d_{Y} | X | X | Y |
| | (no loyalty)_{y} | | | |

The combinations can also be outlined as follows:
(1) a number of loyalty customers who (i) purchased a prior vehicle from the second dealer (Y) and, while (ii) residing in a first-dealer area, associated with the first dealer (X), (iii) purchased a subsequent vehicle from the first dealer (X)
   (a first-dealer geography-based loyalty number, or, L_{YXX});
(2) a number of loyalty customers who (i) purchased a prior vehicle from the second dealer (Y) and, while (ii) residing in the first-dealer (X) area, (iii) purchased a subsequent vehicle from the second dealer (Y)
   (a second-dealer prior-sale-based loyalty number, or, L_{YXY});
(3) a number of loyalty customers who (i) purchased a prior vehicle from the first dealer (X) and, while (ii) residing in a second-dealer area, associated with the second dealer (Y), (iii) purchased a subsequent vehicle from the second dealer (Y)
   (a second-dealer geography-based loyalty number, or, L_{XYY}); and
(4) a number of loyalty customers who (i) purchased a prior vehicle from the first dealer (X) and, while (ii) residing in the second-dealer area (Y), (iii) purchased a subsequent vehicle from the first dealer (X)
   (or a first-dealer prior-sale-based loyalty number, or, L_{XYX}).

Customers having a connection to both dealers, one by geography and one by prior sale, can be referred to as shared customers. For instance, a customer who purchased their prior vehicle from the first dealer (X) but now lives in the area of the second dealer (Y), whether they purchase a replacement vehicle from the first or second dealer, would be considered a shared customer.

Each of the primary four (4) combinations referenced above represents a scenario that can be referred to, with respect to one of the two dealers, as a “pump-in-replacement” or a “pump-out-replacement” sale.

The “in” of “pump-in-replacement” sale can be viewed as referring to scenarios in which a shared customer purchases a replacement vehicle while residing within a subject dealer's assigned geographic area (e.g., AGSSA). For instance, a pump-in-replacement value for the first dealer (X) would include replacement-vehicle sales that the first dealer made to customers who currently reside in the first-dealer area and who purchased their prior vehicle from the second dealer. A pump-in-replacement value for the second dealer (Y) would include replacement-vehicle sales that the second dealer made to customers who currently reside in the second-dealer area and who purchased their prior vehicles from the first dealer.

Pump-in-replacement sales for the first dealer (X), then, would be represented by the first (1) combination above (L_{YXX}). Pump-in-replacement sales for the second dealer (Y) are represented by the third (3) combination above (L_{XYY}).

The “out” of “pump-out-replacement” sales can be viewed as referring to scenarios in which a shared customer purchases their prior vehicle from a subject dealer and currently reside “outside” of the subject dealer's area and purchases a replacement vehicle from the subject dealer. For instance, a pump-out-replacement value for the first dealer (X) would include replacement-vehicle sales that the first dealer made to customers who currently reside in the second-dealer area and who purchased their prior vehicle from the first dealer. A pump-out-replacement value for the second dealer (Y) would include replacement-vehicle sales that the second dealer made to customers who currently reside in the first-dealer area and who purchased their prior vehicle from the second dealer.

Pump-out-replacement sales for the first dealer (X) would, then, be represented by the fourth (4) combination above (L_{XYX}). Pump-out-replacement sales for the second dealer (Y) are represented by the second (2) combination above (L_{YXY}).

Following the operation of generating, or otherwise obtaining, raw pump-in-replacement and pump-out-replacement data or numbers for the first and second dealers (X, Y) at operation 104, flow of the algorithm continued to operation 106 whereat the processing hardware unit 40 generates, using the pump-in-replacement and pump-out-replacement values, or otherwise obtains a pump-in-replacement sales loyalty factor and a pump-out-replacement sales loyalty factor for each of the dealers (X, Y) being compared.

While in some embodiments the computing apparatus 30 is configured to perform a pairwise analysis of two dealers of a product, in contemplated embodiments, the apparatus 30 is configured to compare more than two dealers at a time.

The pump-in-replacement sales loyalty factor from the first dealer (X) perspective is in one embodiment provided according to a relationship whereby the raw pump-in-replacement sales value (L_{YXX}) for the first dealer (X) is divided by the sum of the same value (L_{YXX}) and the pump-out-replacement sales value (L_{YXY}) for the second dealer (Y), or L_{YXX}/(L_{YXX}+L_{YXY}).

The pump-in-replacement sales loyalty factor from the second dealer (Y) perspective can similarly be represented by the relationship: L_{XYY}/(L_{XYY}+L_{XYX}).

The pump-out-replacement sales loyalty factor from the first dealer perspective can be represented similarly by the relationship: L_{XYX}/(L_{XYX}+L_{XYY}).

And the pump-out-replacement sales loyalty factor from the second dealer perspective can be represented by the relationship: L_{YXY}/(L_{YXY}+L_{YXX}).

Although the term pump-in-replacement sales-loyalty (PIL) is used primarily herein in association with the pump-in-replacement sales metric, it is contemplated that the PIL factors could be referred to as a dealer-conquest factor considering that the pump-in basis relates primarily to the condition in which a dealer makes a replacement sale to a customer who purchased their prior vehicle from another dealer. The pump-in-replacement sales-loyalty factors could be represented by, for instance, PIL_{X} for the first dealer and PIL_{Y} for the second dealer.

Pump-in-replacement sales-loyalty is used primarily herein for these cases. The term conquest is reserved generally to refer to scenarios relating to a dealer of a product of a first make, or brand selling a replacement vehicle to a purchaser disposing of a product of another make or brand—e.g., made by a different company or another division of the same company.

Similarly, although the term the pump-out-replacement sales-loyalty (POL) is used primarily herein in association with the pump-out-replacement sales metric, the POL factors can also be referred to as a geographic-conquest factor considering that the pump-out-replacement basis relates primarily to the condition in which a first dealer makes a replacement sale to a customer who resides in a geographic area associated with the other dealer. The pump-out-replacement sales-loyalty factors could be represented by, for instance, POL_{X} for the first dealer and POL_{Y} for the second dealer.

Pump-out-replacement sales-loyalty is used primarily herein for these cases.

The functional relationships for the pump-in and pump-out factors are:

PIL_{X}=L_{YXX}/(L_{YXX}+L_{YXY})(or, pump-in-replacement sales-loyalty_{X}) [Eqn. 1]

PIL_{Y}=L_{XYY}/(L_{XYY}+L_{XYX})(or, pump-in-replacement sales-loyalty_{Y}) [Eqn. 2]

POL_{X}=L_{XYX}/(L_{XYX}+L_{XYY})(or, pump-out-replacement sales-loyalty_{X}) [Eqn. 3]

POL_{Y}=L_{YXY}/(L_{YXY}+L_{YXX})(or, pump-out-replacement sales loyalty_{Y}). [Eqn. 4]

Continuing from operation 106, flow of the algorithm 100 of FIG. 2 proceeds to operation 108. At operation 108, the processing hardware unit 40 generates, using the pump-in-replacement loyalty factors (PIL_{X}, PIL_{Y}) and pump-out-replacement loyalty factors (POL_{X}, POL_{Y}), or otherwise obtains, a total sales loyalty for the first dealer (X), and an indexed total sales loyalty metric (TSL, or SL) for the second dealer (Y).

The indexed total sales loyalty metric (TSL, or SL) is, in various embodiments, a sum of the constituent pump-in loyalty (PIL) and pump-out loyalty (POL) factors. For the first and second dealers, the relationships are respectively as follows:

TSL_{X}=PIL_{X}+POL_{X} [Eqn. 5]

TSL_{Y}=PIL_{Y}+POL_{Y}. [Eqn. 6]

At operation 110, the processing hardware unit 40 generates, based on the indexed total sales metrics (TSL_{X}, TSL_{Y}), a comparative geography-sensitive sales loyalty result. The result can be used in comparing the dealers and identifying opportunities for one or both of the dealers (X, Y) to improve.

In various embodiments, generating the comparative geography-sensitive sales-loyalty object comprises determining, with at least a moderate level of confidence, that the dealer having a higher indexed TSL is the better dealer of the pair (X, Y) in terms of sales loyalty performance. The moderate level of confidence can be referred by other terms, such as modest, weak, or the like, or other.

At decision diamond 112, the unit 40 determines whether either of the dealers (X, Y) has both a higher dealer-pump-in-replacement sales-loyalty factor and a higher dealer-pump-in-replacement sales-loyalty than the other dealer. If no, flow of the algorithm 100 proceeds along path 114 to operation 116 toward a conclusion that only the moderate-level conclusion determined at operation 110 can be reached at this point. In some embodiments, the moderate-level conclusion is the comparative geography-sensitive sales loyalty object, or result, mentioned.

The apparatus 30 is in some embodiments configured to communicate the object to another system, such as a local or remote computing system. In one case, the apparatus 30 is configured to display or initiate display of information corresponding to the output object for providing the information to a receiving computing system and/or personnel to act on the information.

The results, or output objects, as with any result of the present technology, can be reported in other ways. The object(s) may be reported by a formal reported provided in electronic format or hardcopy. The object or report containing the object can be transmitted electronically, such as by email or website, for instance. In some embodiment, the output object is executable by a receiving computer system to (1) perform, based on the object, an action toward improving sales performance, generally, or sales-loyalty-performance, of the recipient organization, or (2) improve evaluation of one or more dealers based on the object. In a contemplated embodiment the output object includes a link to a source comprising code to be executed for one of these two (2) purposes.

In some implementations, from operation 116, the process 100 or portions thereof, is repeated, as indicated generally by path 118, or ended 126.

In various embodiments, from operation 116, flow proceeds to oval 302, representing a beginning of additional operations described below in connection with FIG. 3.

In response to a positive result from the determination at diamond 112, flow of the algorithm 100 proceeds along path 118 to operation 120 whereat the unit 40 determines, with a high level of confidence, that the dealer having both a higher dealer-dealer-pump-in-replacement sales-loyalty factor and a higher pump-out-replacement sales-loyalty factor is the better, or best, dealer of the pair (X, Y) in terms of sales performance.

In some embodiments, the high-level conclusion is the comparative geography-sensitive sales loyalty object, or result, mentioned. The apparatus 30 is in some embodiments configured to communicate the object to another system, such as a local or remote computing system. Or as mentioned, the apparatus 30 can be configured to display or initiate display of information corresponding to content of the object for providing the information a receiving computing system and/or to personnel to act on the information.

As mentioned, output objects can be reported in other ways. The object(s) may be reported by a formal reported provided in electronic format or hardcopy. The object or report containing the object can be transmitted electronically, such as by email or website, for instance. In some embodiment, the output object is executable by a receiving computer system to (1) perform, based on the object, an action toward improving sales-loyalty-performance of the recipient organization, or (2) improve evaluation of one or more dealers based on the object. In a contemplated embodiment the output object includes a link to a source comprising code to be executed for one of these two purposes.

The process 100 or any portion thereof is be repeated, as indicated generally by path 124, or the process 100 is ended 126.

In various embodiments, from operation 122, flow proceeds to oval 302, representing a beginning of additional operations described below in connection with FIG. 3.

FIG. 3

The process 300 represents additional functions. The functions can be additional portions of the algorithm of FIG. 2, or a separate algorithm.

In embodiments, the process 300 uses output from the algorithm of FIG. 2, such as the comparative geography-sensitive sales loyalty object, or result—e.g., the moderate-level or high-level conclusion regarding the better or best dealership in terms of sales loyalty performance.

The present description refers primarily to the computing apparatus 30 as the performing hardware device, though in a contemplated embodiment the processes of FIG. 2 and/or FIG. 3 can be performed by separate devices.

The process 300 commences 302 and flow proceeds to operation 304 whereat the system (e.g., computing apparatus 30) identifies one or more dealerships for which to generate an output, performance-improvement object. In one embodiment, the operation involves determining to generate the performance-improvement object for a dealer of the pair of dealers (X, Y) that was determined the worst dealer, or determined to not be the best dealer.

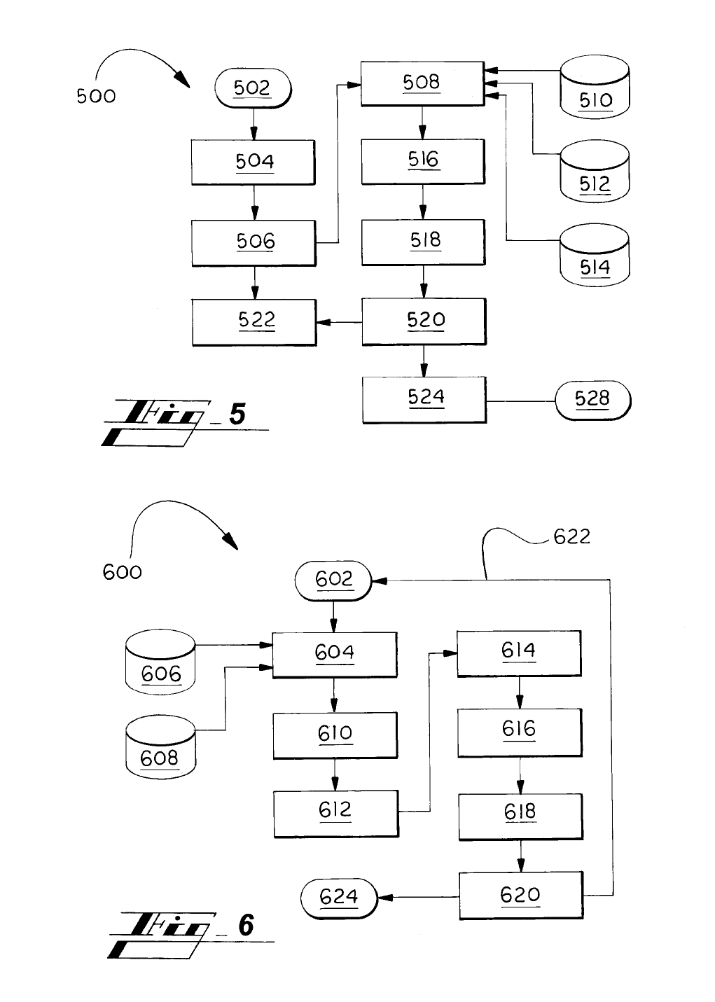

The reference data structure can be constructed or generated in a variety of ways. Generally, the structure is constructed to include correlations between each of various segments or other indications of improvement need, such as pump-in-replacement sales loyalty, and respective pre-determined characteristics that have been determined to improve performance in the segment or other indicated area of need. Generating the reference data structure in some embodiments includes using results of the methods 400-800 of FIGS. 4-8.

Returning to FIG. 3, the determination of operation 304 is in some implementations performed in response to the determination of operation 116 or operation 122 of FIG. 2.

The determination of operation 304 can indicate more than one dealer, whether the dealer(s) is determined better or best in prior analysis, for which to generate recommendation information or other output object characteristic.

At operation 306, the system (e.g., the processing hardware unit 40) generates or determines the performance-improvement object for one or more dealers, such as a worse-performing dealer of a pair (X, Y) compared in the process 100 of FIG. 2.

The performance-improvement output object can indicate, for instance, one or more recommended activities for a dealer to take to improve their sales loyalty performance, and/or one or more diagnostic results that the dealer can use to determine ways to improve sales loyalty performance.

Some general strategies and methods for determining performance-improvement objects are described next in connection with operation 306. Additional methods for determining performance-improvement objects at operation 306 are described farther below in connection with processes 400, 500, 600, 700, 800 of FIGS. 4-8.

In various embodiments, the output object is generated using a reference data structure, which can be arranged in any of various forms. The data can be arranged as a table, such as a lookup table. The data structure can in some implementations is, includes, or is used by a performance model.

In operation, the system consults the reference data and uses context or input information indicating performance of a dealer and/or one or more sales loyalty-performance segments (e.g., a, b, c, d) in which the dealer needs to improve. The system determines at least one output object, using the reference data structure (e.g., lookup table), corresponding to the context information used.

As an example, if an evaluation indicates that a dealer has a low pump-in-replacement sales-loyalty performance, and the reference data structure comprises a relationship between low pump-in-replacement sales-loyalty performance and one or more corresponding recommended improvement actions, the system presenting to the structure the context data regarding the low pump-in-replacement sales-loyalty performance would receive an output objects corresponding to the recommended improvement(s) or receive improvement data for incorporating into an output object or for use in generating the output object.

The performance-improvement object in some implementations indicates one or more controllable factors, which the dealership can change toward desired effect and which, if controlled in a certain manner, would result in an improvement in sales performance—e.g., sales loyalty levels—going forward. Other factors affect dealership performance, but are out of the control of the dealer, and so can be referred to as uncontrollable factors.

Example controllable factors include, but are not limited to, vehicle price, storeroom hours, service-shop hours, and performance in the area of service (e.g., repairs).

Another controllable factor could be overall customer service or satisfaction with the dealer, which can include purchase and service customers. Customer satisfaction is often represented objectively by a metric, such as a customer satisfaction metric, index, value, or the like.

In one embodiment, determining the performance-improvement object includes determining which one or more of multiple controllable factors contributed most, or apparently contributed most to a dealer not performing better in terms of sales. From another perspective, determining the performance-improvement object can include determining which one or more of multiple controllable factors would, if changed, improve or most improve dealer sales performance going forward.

The determination operation 306 can be based on data from any of a wide variety of sources, including data being generated at the apparatus 30. Various data sources external to the apparatus 30, such as databases or servers, are indicated schematically by reference numerals 203-206. The data can include, but is not limited to, one or more benchmark values, competitor data indicating performance and operational metrics of other dealers, data about customers or potential customers (e.g., household data, demographics), geographic data, similar, and other.

In a particular embodiment, determining the performance-improvement object includes determining which of multiple controllable factors is farthest from a pre-established corresponding benchmark. In some implementations, more than one controllable factor is determined. The benchmark can be established by the apparatus, or received by the apparatus 30 such as from a dealer computing system—e.g., system database 202 of FIG. 1.

In a contemplated embodiment, the benchmarks are set based at least in part on performance of other dealers. For instance, if a very-high sales-loyalty dealership has a certain a customer satisfaction metric, their customer satisfaction metric can be used as the benchmark customer satisfaction metric for another dealer, or at least inform determination of a benchmark customer satisfaction metric.

As an example, the system can be configured to, if a dealer is found to (a) be the worst of multiple dealers compared to each other, (b) have a customer satisfaction metric being 8% short of a benchmark customer satisfaction metric, and (c) have service retention is 2% short of a pre-set benchmark for service retention, generate a performance-improvement object indicating need for improving customer satisfaction metric. While changing other controllable factors could improve sales performance, the customer satisfaction metric in this example apparently has the most room for improvement.

In one embodiment, the performance-improvement output object indicates a particular action or actions that the dealer should take. As an example, the output object can indicate, for instance, a recommendation that vehicle price should be lowered, or more particularly lowered by a specific amount or percentage, on all or particular vehicles. As an example, the recommendation can propose hours to have the dealer's storeroom open for customers, or some change to the dealer's current showroom hours. As another example, the recommendation can indicate proposed hours to have the dealer's service department open to customers, or some change to the dealer's current service hours.

In a contemplated embodiment, determining the performance-improvement object includes determining, in connection with an underperforming dealer in terms of sales loyalty, which of the sales loyalty metrics or factors is farthest from a target or benchmark value. The operation can involve, for example, determining which of pump-in-replacement sales for the dealer (e.g., L_{YXX} regarding dealer X) and pump-out-replacement sales for the dealer (e.g., L_{XYX} for dealer X) should be improved. Or, the operation can include determining which of pump-in-replacement sales for the dealer and pump-out-replacement sales for the dealer would improve sales loyalty performance the most.

From operation 306, the algorithm 300 or any portion thereof, can be repeated, as indicated generally by path 308, or end 310. Similarly, from operation 306, flow of the algorithm 300 can proceed to the beginning of the process 100 of FIG. 2, or any portions thereof, or end 310.

FIG. 4

The process 400 of FIG. 4 represents other example functions that can be performed in connection generating a performance-improvement object, such as in connection with operation 306 of FIG. 3.

Flow begins 402 and proceeds to operation 404 whereat a hardware system (including, for instance, a hardware processing unit), such as that of an automotive dealership, manufacturer, or other service provider, generates or otherwise obtains sales loyalty data regarding a dealer. A manufacturer or distributed system may, for example, receive sales-loyalty data about one or more dealers for processing in order to generate a performance-improvement object.

At operation 406, the performing hardware system receives, determines, or otherwise receives one or more costs to use, in connection with each of a plurality of controllable factors, for subsequent use in determining (operation 408) a cost-benefit relationship. The cost(s) may be referred to by other terms, such as cost level, cost value, investment, investment level, the like, or other.

The benefit in various embodiments is an expected increase in sales loyalty—e.g., in any one or more, or a combination or summation of sales loyalty measures. The benefit could represent, for instance, an increase, corresponding to the investment, expected in the way of pump-in-replacement sales loyalty, pump-out-replacement sales loyalty, repeat sales, or a combination or summation of any of these.

Generally speaking, controllable factors are factors that can be changed by a dealer to affect sales performance, and particularly sales-loyalty performance for the dealer. Example controllable factors include showroom floor hours (e.g., hours that the showroom is open at the dealership), service hours (e.g., hours of operation for the service department at the dealership), price (e.g., sales price asking for vehicles on the lot), customer satisfaction metric, advertisement, and service retention (i.e., repair and maintenance loyalty).

A cost-benefit relationship relates a potential investment amount to an expected benefit. The investment can be made in any of a variety of forms, such as monetary investment or capital, time, utilities, materials, other resources, work, or other. The investment can also be converted to any desired base form, such as money. The system can include, for instance, algorithms for converting any type of investment to a monetary equivalent. Keeping a showroom or service department open later requires additional at least additional employee pay and electricity for lights, HVAC, etc., all of which can be converted to a financial value. These systems can be configured (e.g., programmed) to convert such one or more relevant characteristics to a monetary equivalent.

Regarding customer satisfaction, a proprietary or common index, such as a customer-satisfaction metric can be used. The algorithm can have programmed within it, or have access to, data indicating types and amounts of investments that can be made to increase the customer satisfaction metric. Some of these may overlap with other factors, such as having longer showroom hours. Other customer satisfaction metric-related investments could include, for instance, improved phone or online customer service, or follow-up communications after services are performed.

Regarding service retention, any proprietary or known method of measuring service retention can be used. The algorithm can have programmed within it, or have access to, data indicating types and amounts of investments that can be made to improve service retention. Some of these may overlap with other factors, such as having longer service hours. Other service-retention investments could include, for instance, improved phone or online customer service, employee training or rewards programs, or dealer-initiated follow-up communications after services are performed.

For the cost-benefit analysis, the level or value of the cost can be selected in any of a variety of ways. In a first of two primary ways to select a level or value of the cost, the system applies the same cost level against each of the selected controllable factors. The system can use as a common benefit for each controllable factor an investment of, for instance, $10,000. In this example, the cost-benefit algorithm, then, would determine how much improvement in sales loyalty (SL) would be effected by a $10,000 investment.

An advantage to using a common cost across each controllable factor is that the factors can be compared based on the same foundation. Another advantage of this first approach is that the cost can be selected strategically. The cost can be selected based on context data relating to a present situation. For instance, if available data indicates that a subject dealership has $150,000 available to invest in improvements, then the cost value can be set at $150,000 toward determining how the amount can be most-effectively applied to improve sales, or specifically sales loyalty.

In the second of two exemplary manners of selecting a level or value of the cost to use in the cost-benefit analysis, the algorithm can be configured to cause the system to determine, in connection with each controllable factor, a cost that would result in the most efficient use of funds in connection with the factor. In this embodiment, the cost determined would be that which would lead to, in common vernacular terms, the biggest bang for the buck.

If, for instance, a $10,000 investment by a subject dealership in a particular controllable factor (e.g., customer service or satisfaction) for the dealer would increase sales loyalty (SL) for the dealer by a multiple of “z,” an investment of $15,000 investment would effect an increase in sales loyalty of 2 z, and a $30,000 investment would effect an increase of 2.1 z, the system could determine that the $15,000 investment would be most effective. Of these options, the $15,000 investment in customer service improvements would be the most bang for the buck for the dealership in connection with customer service, because (a) this amount will yield twice the sales loyalty improvement than the $10,000 investment, though being only 50% more in investment ($15 k vs. $10 k) and (b) while the higher investment of $30,000 yields a higher improvement in sales loyalty (2.1 z), the 0.1 z increase is not worth (i.e., sufficiently proportionate to) the much higher investment ($30,000) required to obtain the benefit.

For this second manner, the system uses cost-benefit data indicating an effect of investment (e.g., money, resources, and/or other) on corresponding improvement in sales loyalty. The cost-benefit data can be part of or result from execution of one or more performance models. The models are described further in connection with FIG. 5, below.

The cost-benefit data can be created based on, for instance, historic investments and resulting sales-loyalty improvements at one or more dealerships. For instance, if available information indicates that a $10,000 investment resulted in an improvement of y %, then cost-benefit the data can indicate this relationship.

The cost-benefit data, indicating an effect of investment (e.g., money, resources, and/or other) on corresponding improvement in sales loyalty, can also be created based on performance and activities at one or more other dealerships. For example, if another dealership is found to have very similar characteristics (similar local potential-customer demographics, age and quality building, customer service scores (e.g., customer satisfaction metric), etc.) to a subject dealership except that the other dealership has much longer service hours, then the data can be set to indicate that an investment in an amount needed to bridge the difference in service hours (i.e., the cost of opening service the extra hours) would result in an improvement in sales loyalty equal to the difference in sales loyalty that separated the two dealerships.

Using the cost(s) obtained at operation 406, the system at operation 408 uses the cost(s) to determine, for each controllable factor, the associated improvement in the controllable factor. For instance, under the first manner described above for obtaining the applicable cost value for each controllable factor, the common cost value obtained (e.g., $10,000) is used to determine a corresponding improvement for each one of the controllable factors.

This example can be continued using any of the example controllable factors described above—e.g., showroom or floor hours, service hours, price, customer-satisfaction, advertisement, service retention, or other.

At operation 410, the system determines a ratio of expected sales-loyalty improvement per cost invested for each controllable factor. The ratio is determined by dividing the expected sales loyalty improvement by the cost determined at operation 408.

If each controllable factor is referenced by letter i, each pre-set or proposed cost is referenced by C, and the ratio for each controllable factor can be represented by SLᵢ/Cᵢ.

At operation 412, the system determines the controllable factor having the highest sales-loyalty-to-cost ratio (SLᵢ/Cᵢ). In some embodiments, the system arranges the controllable factors from the one having the highest sales-loyalty-to-cost ratio (SLᵢ/Cᵢ) to the one having the lowest ratio (SLᵢ/Cᵢ). With each ratio represented by SLRᵢ, the relationship can be shown by:

SLRᵢ=SLᵢ/Cᵢ [Eqn. 7]

At operation 414, the system generates, and in some cases, communicates, an output object such as a recommendation for action to improve sales loyalty performance for at least a subject dealer.

The system can be configured to, if the system determines at operation 412 that an investment in customer service would be a most-effective investment to improve sales-loyalty level in a particular segment, generate at operation 414 the object to include a suggested action for the dealership take to improve customer service, such as upgrading a phone or communications system, increasing hours, and/or personnel training.

Regarding communicating the output object, the system can communicate the object in any of a variety of ways, as mentioned. The object, or data indicating content of the object, can be displayed on a screen, communicated electronically, and/or printed. The object in some embodiments comprises actionable computer code, which when executed, causes the system to perform improvement activity, such as initiating one or more actions toward improving the highest ranked controllable factor from operation 412.

As mentioned, output objects can be reported in other ways. The object(s) may be reported by a formal reported provided in electronic format or hardcopy. The object or report containing the object can be transmitted electronically, such as by email or website, for instance. In some embodiment, the output object is executable by a receiving computer system to (1) perform, based on the object, an action toward improving sales-performance of the recipient organization, or (2) improve evaluation—e.g., improve evaluation accuracy—of one or more dealers based on the object. In a contemplated embodiment the output object includes a link to a source comprising code to be executed for one of these two purposes.

From operation 414, the process 400, or any portions thereof, is repeated, as indicated generally by path 416, or end 418.

FIG. 5

The process 500 of FIG. 5 represents another example process that can be performed for generating a performance-improvement object, such as in connection with operation 306 of FIG. 3. The process 500 is in various embodiments performed to generate, share, and/or use data about latent factors. The data is generated, shared, or used to improve dealer performance and/or performance-evaluation models, such as the models referenced above in connection with the cost-benefit data used at operations 406 and/or 408, or the models described in FIG. 7.

The process 500 in various embodiments includes any one or more functions of known quality improvement systems, such as the Red X® or Shainin strategy or system. (RED X is a registered trademark of Red Ex Holdings, LLC of Reno, Nev.).

In some implementations, the process 500 is performed in connection with each of multiple dealers, and each of multiple sales-geography loyalty customer segments. The segments include the four (4) geography-based loyalty and/or prior-sale-based loyalty scenarios labeled a, b, c, d, described above.

Flow of the algorithm 500 begins 502 and proceeds to operation 504 whereat the system generates or calculates for each of multiple subject dealers, a sales-loyalty difference. The sales-loyalty difference is the difference between an actual sales loyalty level for the dealer and a benchmark or target sales-loyalty level. In another embodiment the sales-loyalty difference is the difference between an actual sales loyalty level for the dealer and a statistical model, such as shown below by Equation 10.

The sales-loyalty difference can be represented as:

δ=ASL−BSL [Eqn. 8]

with δ (lower case Greek letter delta) being the sales-loyalty difference, ASL being the actual sales loyalty value, and BSL being the benchmark sales loyalty level.

In one embodiment, the benchmark sales loyalties (BSL) used are the same for each dealer being evaluated. For instance, with sales loyalty represented as a percentage, a benchmark sales loyalty could be set at 50% (or a particular statistic of the distribution of all dealers such as the sales loyalty percentage that is higher than that of 80% of dealers) for every dealer evaluation, for the segment in which a dealer sold a replacement vehicle to a customer who purchased a vehicle being replaced from the same dealer while residing in an area associated with the dealer.

Use of the term segment in this sense is different than the common use in the automotive industry to refer to segments of vehicles such as “luxury,” “small utility,” or “sports car.” Here the term is used to refer to the situations, subsets, categories, or scenarios outlined, such as one in which in which a dealer sold a replacement vehicle to a customer who purchased a vehicle being replaced from the same dealer while residing in an area associated with the dealer. At times, one or more of the other terms, such as category, is used to refer to these groups.

To illustrate the various scenarios, FIG. 9 shows actual sales loyalty (ASL) levels and benchmark sales loyalty (BSL) levels in connection with an example dealer. Continuing with the last example, the actual sales loyalty (ASL) is shown as 50% for the scenario in which the customer purchased a vehicle being replaced from the dealer X while living in the area of the dealer X. The scenario is labeled by reference numeral 908 in FIG. 9. The corresponding benchmark, at 50% by way of example, is indicated by reference numeral 916 for this scenario.

The chart 900 of FIG. 9 includes an x-axis 902 indicating sales loyalty percentages. Values for sales loyalty are shown in connection with the four primary scenarios or categories mentioned.

The first column 904 indicates whether a subject dealer sold to the customer a prior vehicle being replaced. Reference numeral 904₁ represents the case in which the dealer sold a vehicle being replaced to a customer, and reference numeral 904₂ represents the case in which the dealer did not sell the vehicle being replaced to the customer. The second column 906 indicates whether the customer resided in an area of the subject dealer when they purchased the replacement vehicle. Reference numeral 906₁ represents the case in which the customer resided in an area associated with the dealer when they purchased the replacement vehicle, and reference numeral 906₂ represents the case in which the customer did not live in the area associated with the dealer when they purchased the replacement vehicle.

Accordingly, data bars 908, 910, 912, 914 represent these various scenarios as follows:

TABLE 4

| Reference | Scenario |
|---|---|
| 908 | Dealer sold a replacement vehicle to a customer who |
| | purchased the vehicle being replaced from that dealer |
| | while residing in an area of that dealer |
| 910 | Dealer sold the replacement vehicle to a customer |
| | who purchased the vehicle being replaced from that |
| | dealer while not residing in that dealer area |
| 912 | Dealer sold a replacement vehicle to a customer who |
| | did not purchase the vehicle being replaced from that |
| | dealer though residing in that dealer area |
| 914 | Dealer sold a replacement vehicle to a customer who |
| | did not purchase the vehicle being replaced from that |
| | dealer when residing outside of that dealer area |

The data bars 908, 910, 912, 914 can further be equated to the four primary performance segments (a, b, c, d) described above as follows:

TABLE 5

| | | Seg- |
|---|---|---|
| Reference | Scenario | ment |
| 908 | Dealer sold a replacement vehicle to a customer who | a |
| | purchased the vehicle being replaced from that dealer | |
| | while residing in an area of that dealer | |
| 910 | Dealer sold the replacement vehicle to a customer | c |
| | who purchased the vehicle being replaced from that | |
| | dealer while not residing in that dealer area | |
| 912 | Dealer sold a replacement vehicle to a customer who | b |
| | did not purchase the vehicle being replaced from that | |
| | dealer though residing in that dealer area | |
| 914 | Dealer sold a replacement vehicle to a customer who | d |
| | did not purchase the vehicle being replaced from that | |
| | dealer when residing outside of that dealer area | |

Data bars 908 (or, a), 910 (or, c), 912 (or, b) can be said to represent the actual sales loyalty (ASL) levels or values, in terms of percentages, for the subject dealership. The fourth data bar 914 (or, d) can be referred to as an actual sales loyalty (ASL) value, though it corresponds to a scenario in which a subject dealer sells a replacement vehicle to a customer who resides outside of the subject dealer area and purchased a vehicle being replaced from another dealer.

Corresponding benchmarks sales-loyalty (BSL) levels for the first three segments are indicated by reference numerals 916, 918, 920. The fourth benchmark 922 can also referred to as a benchmark sales loyalty (BSL) value, though it corresponds to the scenario in which a subject dealer sells a replacement vehicle to a customer who purchased a vehicle being replaced from another dealer while living outside of an area of the subject dealer.

Returning to the algorithm 500 of FIG. 5, and more particularly, the second function operation 504 thereof, while the benchmark-sales loyalty (BSL) levels used are in some embodiments the same for each dealer being evaluated. As mentioned, in other embodiments, the benchmarks 916, 918, 920, 922 are calculated separately for each dealership being evaluated in the process 500.

At operation 506, the system identifies a best-performing dealership and a worst-performing dealer, of the dealers compared, based on their respective sales-loyalty differences (δ) calculated at operation 504. In one embodiment, the system at operation 506 ranks, or orders, each of the dealerships being evaluated based on their respective sales-loyalty differences (δ), yielding a best-performing dealership, having the highest sales-loyalty differences (δ) of the group, and a worst-performing dealership, having the lowest sales-loyalty differences (δ) of the group. In another embodiment the system compares the dealer that most outperforms the statistical model with the dealer that most under-performs the statistical model.

At operation 508, the system compares the best and worst dealers in one or more ways. The system in various embodiments considers one or more pieces of ancillary data in doing so.

The comparison is in various embodiments performed to determine any latent factors by which the best and worst dealers differ and which apparently or may explain a difference in performance between the subject dealer, or all dealers, and its benchmark/their benchmarks in each category (e.g., in each scenario a, b, c, d). The latent factors can indicate differences in dealer operation that explain the difference between (1) the dealer having the highest sales-loyalty difference (δ) and the one having the lowest and (2) dealer performance in a segment and the dealer's benchmark.

In one embodiment, latent factors are factors that are not captured in the benchmark. The latent factors may include factors that account for differences between the actual sales loyalty (ASL) levels and the benchmark sales loyalty (BSL) levels in each evaluated sales-geographic-loyalty category (a, b, c, d), whether positive (i.e., the ASL is higher) or negative (i.e., the BSL is higher).

In embodiments where the benchmark is based on all known factors, the Shainin strategy, or comparable approach, can be used to discover latent factors by comparing a pair of dealers—e.g., similar dealers. A first dealer is identified as the one whose performance most exceeds the benchmark, and the second dealer is identified as the one whose performance falls furthest below the benchmark. The large performance gap between these two dealers magnifies the impact of factors unknown to the benchmark. Comparing the operations, situation, environment and other factors for these dealers can uncover possible latent factors that could help explain the performance (relative to the benchmark) for these two dealers. These newly identified latent factors can then be incorporated in future performance benchmarks and statistical models.

As mentioned, the ancillary data, in various embodiments, includes information such as customer comments or other customer feedback, which can be referred to collectively as customer feedback 510. The feedback data can be include, for example, scores or rankings provided by customers, such as customers of vehicle sales and/or service. The customer feedback 510 is in some implementations specific to only a dealership being evaluated. In a contemplated embodiment, the customer feedback is compiled before or as part of the consideration of operation 508, such as by being consolidated into one or more tables, charts, scores, or rankings.

The ancillary data, in one embodiment, includes dealer data 512 from a system such as a corporate system that warehouses data from its outlets or franchises, or from each of the dealer's individual data management systems. The dealer data can include, for instance, customer-satisfaction information, facility information (such as building age, renovations, floor space, parking space, and tooling capacity), staffing information (such as the number of employees, certifications, turnover, and training records), expense data (such as advertising expenditures), and inventory levels.

The ancillary data, in one embodiment, includes interview and/or inspection data, referred to generally herein as inspection data 514. This data can include, for instance, results from an inspection performed by an entity, such as a manufacturer, or an entity having an operation inspecting dealers. The inspection data 514 can include, for example, scores or rankings provided by the inspecting entity.

The inspection data 514 is in some implementations specific to a dealership being evaluated. In a contemplated embodiment, the inspection data is compiled before or as part of the consideration of operation 508, such as by being consolidated into one or more tables, charts, scores, or rankings. Inspection data can include information about cleanliness, the clarity of signage, the ease of navigating the facility, the attractiveness and safety of the dealer's neighborhood, amenities and services located nearby (such as restaurants, shopping outlets and public transportation), dealer-specific rewards programs and offers, customer waiting time, and dealer business processes.

Returning to the flow of the process 500, at operation 516, the system performs a testing function to determine the efficacy, or at least effect, of the latent factors identified (operation 508). The function involves the system examining impact of the latent factor(s) on other dealers. Testing-function output includes one or more latent factors that appear to explain at least some of the determined difference in performance for a category (e.g., a, b, c, d), or sales-loyalty difference (δ). The function can evaluate whether, or if, observed differences in candidate latent factors explain some or all of the sales-loyalty differences.

At operation 518, the system obtains the testing-function output including the latent factors that appear to explain at least some of the determined difference in performance for a category (e.g., a, b, c, d), or sales-loyalty difference (δ). The following operations 520, 522, 524 are performed in connection with latent factors obtained.

At operation 520, the system determines at least one manner by which the highest-performing dealership in the subject segment, identified as having the highest sales-loyalty difference (δ) for the segment at operation 506, performed regarding each of the latent factors obtained by the prior operations 516, 518. The manner determined can be referred to as a treatment. The treatment(s) are in some embodiments stored as target, or best-practice ways to treat (e.g., perform with respect to) these latent factors. If number of service hours is identified as a latent factors, and a higher-performing dealer has twice as many service staff, having twice as many service staff, or a certain number of service staff that the dealer has, can be stored as a target treatment for the latent factor of the subject segment.

At operation 522, the system communicates the best-practice treatment(s) of operation 520 as an output, performance-improvement, object. The operation 522 can be a comprisal of the operation 306 of the algorithm 300 of FIG. 3 for generating a performance-improvement object for one or more dealers.

The system, in some embodiments transmits the output object, indicating the best-practice treatment(s), performance-improvement object in various embodiments includes a recommendation, to an evaluated dealer and/or other dealers. The output, performance-improvement object shared can be acted upon by a receiving entity to improve performance of the receiving entity. A dealer can adjust its operations to improve performance in accord with the output object, for instance. In a contemplated embodiment, the output object is a message configured with code to be processed by a computing system of the receiving entity to institute at least one improvement or improvement recommendation. The performance-improvement object can include, for instance, a recommendation to increase showroom hours, or send, more and/or more-timely wellness check letters or emails to customers having visited the dealer recently.

At operation 524, the system incorporates the latent factors obtained in operations 516, 518 into at least one performance model used to evaluate dealerships. The performance model is in some embodiments, the model used to determine benchmark sales loyalty performance.

The operation 524 in some cases includes collecting information relevant to the latent factors obtained, such as information useful for objectifying or otherwise configuring data regarding the latent factors for incorporation into the performance model. In some embodiments, incorporating the latent factors in a performance model involves incorporating the latent factors obtained into the cost-benefit data used at operations 406 and/or 408, as referenced above.

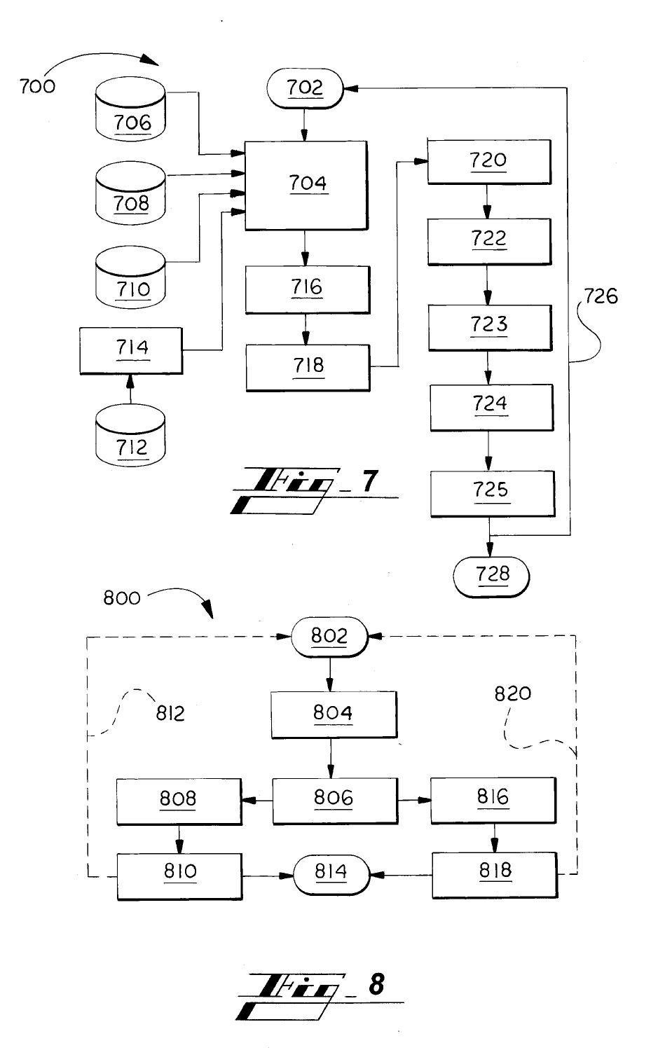

The performance models include in various embodiments, one or both of the processes 600, 700 described below in connection with FIGS. 6 and 7, for example.

The process 500, or any portions thereof, can be repeated for each segment (e.g., a, b, c, d) and subject dealers being evaluated, as indicated by return flow path 526, or ended 528.

FIG. 6

FIG. 6 illustrates a process 600 for applying one or more statistical models to determine, based on a plurality of uncontrollable factors, target sales-loyalty levels or values for each evaluation segment.

As with the other processes described, this process 600 is in various embodiments performed by a hardware-based system (including, for instance, a processing device), such as that of an automotive dealership, manufacturer, or other service provider.

Flow of the algorithm 600 commences 602 and flow proceeds to the first-illustrated operation 604, the system calculates statistical association between each of numerous uncontrollable factors 606 and actual performance of a dealer in each of multiple categories, such as the primary four segments mentioned (a, b, c, d). Uncontrollable factors can include context data that affects or could affect dealer performance, but which are generally or completely out of the control of a dealer. The uncontrollable factors in various embodiments include information such as household data, competitor data, geographic data, governmental data (such as sales tax rates and limits on business hours), and other.

Input for the operation 604 also includes dealer data 608 indicative of sales performance for the dealer(s) being evaluated. The dealer data 608 includes or indicates factors affecting the sales performance of one or more dealers being evaluated. Dealer data could include sales or service volumes relative to the potential number of customers in the dealer's area, and customer satisfaction with the sales or repair or maintenance processes.

Further regarding the uncontrollable factors, household data can include, for instance, or code configured for evaluating demographics about households in a geographic area, such as the area of geographic sales and service advantage (AGSSA), or statistics about such demographics. Example demographics include household income, net worth, number and age of family members, credit scores of one or more family members, number and age of family member of and/or nearing driving age, and existing cars per household.

Competitor data can include, for instance, data about such indicators, or code configured for evaluating such indicators. The competitor data in various embodiments includes operation indicators, such as hours of operation and product or service pricing of other dealers of the same or different brands. The competitor data can also include the density of competition relative to population in an area.

Geographic data can include any of customer residence location, location of dealer, location of other dealers such as competitors, population, average driving time from each potential customer in the dealer's area to a subject dealer, the distance from the subject dealer to the nearest other same-brand dealer and distance to the nearest different-brand dealer, and government jurisdiction that could impact taxes and regulations.

At operation 610, a function such as a factor analysis is performed to identify top factors, and to reduce collinearity among candidate factors in each of the subject segments (e.g., a, b, c, d). In some embodiments, to generate dealer specific benchmarks for each of the four sales-geographic-loyalty categories (a, b, c, d), all factors both controllable and uncontrollable are considered. In another implementation, to provide dealer-specific improvement guidance only uncontrollable factors determined to have an effect on dealer performance in one of the four sales-geographic-loyalty segments (a, b, c, d) are considered and that dealer's uncontrollable factors are set to the actual values for that dealer. In another implementation, the dealer's performance in each of the four sales-geographic-loyalty categories (a, b, c, d) is compared to the set of all dealers with similar uncontrollable factor values.

Regarding the collinearity function, the system identifies overlapping factors being present already in a relevant performance model and removes such overlapping factors. In some embodiments, the overlap need not be complete—e.g., a total match—and can be partial, by way of an identified relationship. As an example, if the top uncontrollable factors identified include number of household members of driving age, the algorithm 600 may be configured to determine that the factor is sufficiently related to a factor already in the performance model, such as numbers of vehicles in the household, and so remove the new, related uncontrollable factor—i.e., remove the newly identified uncontrollable factor of the number of household members of driving age.

At operation 612, the system performs one or more test transformations of remaining top uncontrollable factors identified and not removed in the previous operation 610. These remaining top uncontrollable factors can be referred to as significant, or substantial heavy, non-collinear uncontrollable factors, because they were identified as relevant, and not removed for being collinear in the previous operation. Taken together, these non-collinear uncontrollable factors describe the dealer's environment.

At operation 614, the system selects the most-potent non-collinear uncontrollable factors. The most-potent non-collinear uncontrollable factors are, in one embodiment, factors determined to have a sufficient effect on dealer performance in one of the four sales-geographic-loyalty segments (a, b, c, d), such as an affect above a predetermined threshold level of influence, which in some implementations is higher than the threshold level of influence mentioned above.

For use in equations, the non-collinear uncontrollable factors can be referred to by uᵢₖ(D), where i represents the number of the factor (e.g., first of multiple identified factors, second of the multiple factors, etc.), k represents the category (e.g., loyalty-sales segments a, b, c, d), and D represents the dealer.

At operation 616, the system performs one or more functions to estimate, or generate an estimation of, dealer performance in each of the subject sales-geographic-loyalty segments (e.g., a, b, c, d). The functions comprise generating, or creating, a statistical model of selected uncontrollable factors, selected at operation 614. The statistical model can be generated based on the following equation, with N denoting a number of uncontrollable factors in the statistical model:

fₖ(U(D))=fₖ(u₁ₖ(D),u₂ₖ(D), . . . ,u_{Nk}(D)) [Eqn. 9]

In one embodiment this relationship is a logistic regression model in which the system, as part of this operation 616, matches, or fits, the logistic regression model, having the uncontrollable factors incorporated, to actual measured or observed sales loyalty of all dealers being evaluated in each category.

At operation 618, for each dealer (D), the system determines or calculates a target sales loyalty (TargSL) for each of the subject categories (e.g., the four sales-geographic-loyalty segments a, b, c, d) based on the uncontrollable factor values for the dealer—e.g., values of the most-potent non-collinear uncontrollable factors selected at operation 614 for the dealer.

At operation 620, the system stores, sends, and/or uses the determined target sales-loyalty (TargSL) value(s) for the dealer. The determined target sales-loyalty (TargSL) value(s) can be used to update one or more performance models. Another use of the target sales-loyalty (TargSL) value is as a benchmark. As a benchmark, TargSL can (i) be the benchmarks described above and shown in FIG. 9 and/or (ii) be or in connection with the benchmark-sales value (BSL) of Equation 8.

The system in various embodiments sends the target sales loyalty (TargSL) value to any computer, such as of a dealership or evaluating entity, for use there in evaluating performance of one or more dealers or improving performance of one or more dealers.

In a contemplated embodiment, the operation 620 involves using the TargSL values to perform a sensitivity analysis on the uncontrollable factors for each dealer to inform decisions about adding, subtracting, or relocating dealers. In a contemplated embodiment, the operation 620 involves sending the TargSL values to a receiving device for use in performing a sensitivity analysis on the uncontrollable factors for each dealer inform decisions about adding, subtracting, or relocating dealers.

The process 600, or any portions thereof, can be repeated, as indicated by flow path 622, or end 624.

FIG. 7

FIG. 7 illustrates a process for applying statistical models to determine, based on a plurality of uncontrollable factors and controllable factors, target sales-loyalty values for each of multiple evaluation categories—e.g., sales-geographic-loyalty segments a, b, c, d, described above.

The process 700 of FIG. 7 is in various embodiments performed by a hardware-based system (including, for instance, a processing device), such as that of an automotive dealership, manufacturer, or other service provider.

The process 700 begins 702 and flow proceeds to operation 704 whereat the system calculates statistical association between actual performance of a dealer in each of multiple categories, such as the four exemplary segments mentioned (a, b, c, d), and both (i) numerous uncontrollable factors 706 and (ii) controllable factors 708.

Uncontrollable factors can be those described above. Controllable factors are, generally, those affecting dealership sales performance, e.g., sales-loyalty performance, and being within control of the dealership. Example controllable factors include, but are not limited to, vehicle price, storeroom hours, service-shop hours, and performance in the area of service (e.g., repairs).

In various embodiments, input for the operation 704 also includes dealer data 710 indicative of sales performance and/or qualities, and/or service-related performance or qualities, for the dealer(s) being evaluated. In one embodiment the dealer data 710 includes service data.

The dealer data 710 can be like that described above in connection with data 608 of FIG. 6.

In various embodiments, input for the operation 704 also includes cost data and/or pricing data 712, such as data regarding costs for, or pricing of, a subject dealer and data regarding cost/pricing of one more other dealers, such as one or more local dealers.

The operation 704 can use the cost and/or pricing data directly, or after processing 714. The pre-processing 714 can be performed before or as part of the operation 704. The pre-processing 714 can include using or generating a model for cost and/or price elasticity. The model may indicate, as an example, that while customers may pay $12,000 for a vehicle, and perhaps $12,500, customers would generally not purchase a vehicle if it is priced near $13,000 or higher.

In embodiments, pricing is a factor controllable by the dealer and its impact can be represented by a model for price elasticity. The pricing can be determined by modeling the elements of the sales transaction such as cost, trade-in value relative to intrinsic value, finance terms, lease-interest rate, lease-residual value, and markup on accessories and additional services such as extended warranties or free maintenance. In one embodiment, elements of a sales transaction for a subject dealer are compared to corresponding data for actual transactions for the subject dealer and/or one or more other dealers, to estimate a price elasticity. The price elasticity can then be used to quantify impact of changes to a subject dealer's pricing on sales loyalty performance given levels of other controllable factors.

Generally, in embodiments, estimating the impact of price requires (i) analyzing all the elements of the transaction and (ii) estimating a price elasticity.

At operation 716, a function such as a factor analysis is performed to find top factors, and to reduce collinearity in each of the subject segments (e.g., a, b, c, d). In some embodiments, all uncontrollable factors and controllable factors being considered are considered as top factors. In another implementation, only uncontrollable factors and controllable factors determined to have an effect on dealer performance in one of the four sales-geographic-loyalty segments (a, b, c, d) are considered as top factors. In still another implementation, only uncontrollable factors and controllable factors determined to have a sufficient effect on dealer performance in one of the four sales-geographic-loyalty segments (a, b, c, d) are considered as top factors, such as an affect above a predetermined threshold level(s) of influence.

Regarding the collinearity function, the system identifies overlapping factors, which can be similar to or the same as described above in connection with operation 610.

At operation 718, the system performs one or more test transformations of remaining top factors identified and not removed in the previous operation 716. These remaining top factors can be referred to as heavy, or promising, non-collinear factors, because they were identified as relevant, and not removed for being collinear in the previous operation.

At operation 720, the system selects most-potent non-collinear uncontrollable factors and most-potent non-collinear controllable factors. In one embodiment, the most-potent non-collinear uncontrollable factors have already been determined, such as at operation 614 of the process 600.

The most-potent non-collinear uncontrollable factors and controllable factors are, in one embodiment, factors determined to have a sufficient effect on dealer performance in one of the four sales-geographic-loyalty segments (a, b, c, d), such as an affect above a predetermined threshold level of influence, which in some implementations is higher than the threshold level of influence mentioned above.

Again, the non-collinear uncontrollable factors can be referred to by uᵢₖ(D). The non-collinear uncontrollable factors can be referred to by cᵢₖ(D), where i represents the number of the factor (e.g., first of multiple identified factors, second of the multiple factors, etc.), k represents the category (e.g., loyalty-sales segments a, b, c, d), and D represents the dealer.

At operation 722, the system performs one or more functions to estimate, or generate an estimation of, retailer performance in each of the subject sales-geographic-loyalty segment (e.g., a, b, c, d). The functions comprise generating, or creating, a statistical model of selected controllable and selected uncontrollable factors from operation 720. The statistical model can be generated based on the following equation, with N denoting a number of uncontrollable factors in the statistical model and M denoting a number of controllable factors in the statistical model:

gₖ(C(D),U(D))=gₖ(c₁ₖ(D),c₂ₖ(D), . . . ,c_{Mk}(D),u₁ₖ(D),u₂ₖ(D), . . . ,u_{Nk}(D)) [Eqn. 10]

In one embodiment, this relationship can be a logistic regression model in which the system, as part of this operation 722, matches or fits the logistic regression model to actual, measured or observed sales loyalty of all dealers being evaluated in each category.

In one embodiment, the method 700 comprises an operation 723 of, for each dealer (D), the system determines or calculates a target sales loyalty (TargSL) for each of the subject categories (e.g., the four sales-geographic-loyalty segments a, b, c, d) based on the uncontrollable factor values and/or controllable factor values for the dealer—e.g., values of the most-potent non-collinear uncontrollable and controllable factors selected at operation 720 for the dealer. In one embodiment, this target sales loyalty is determined by setting the controllable factor values to their average over all dealers. In another embodiment, for each of the four sales-geographic-loyalty segments, each controllable factor value is set to the value observed among all dealers that maximizes sales loyalty.

The system at operation 724 perform a sensitivity analysis, on the controllable factors in gₖ(C(D),U(D)) for each dealer, to prioritize improvement opportunities.

In the embodiment in which the method 700 comprises the operation 723 of determining or calculating the target sales loyalty (TargSL), the method 700 can include, in performing the sensitivity analysis 724, perform the sensitivity analysis on the controllable and/or uncontrollable factors for each dealer to prioritize improvement opportunities. In a contemplated embodiment, the operation involves sending the TargSL values to a receiving device for use in performing a sensitivity analysis on the controllable and/or uncontrollable factors for each dealer to prioritize improvement opportunities.

In various embodiments, the method 700 comprises an operation 726 of determining one or more profit-maximizing changes for controllable factors. The operation 726 can include the processor using price and/or cost information, along with the factor elasticities (e.g., those from step 724), to find the profit-maximizing changes to controllable factors including price and/or cost. In one embodiment, the processor determines dealer profit as a product of sales and dealer price less the costs of changing the levels of the controllable factors. In one embodiment, the processor, using an optimization search algorithm, such as a genetic algorithm, searches alternative prices levels and other controllable factor levels to find the combination that maximizes dealer profit.

The process 700 or any portions thereof can be repeated, as indicated by flow path 726, or end 728.

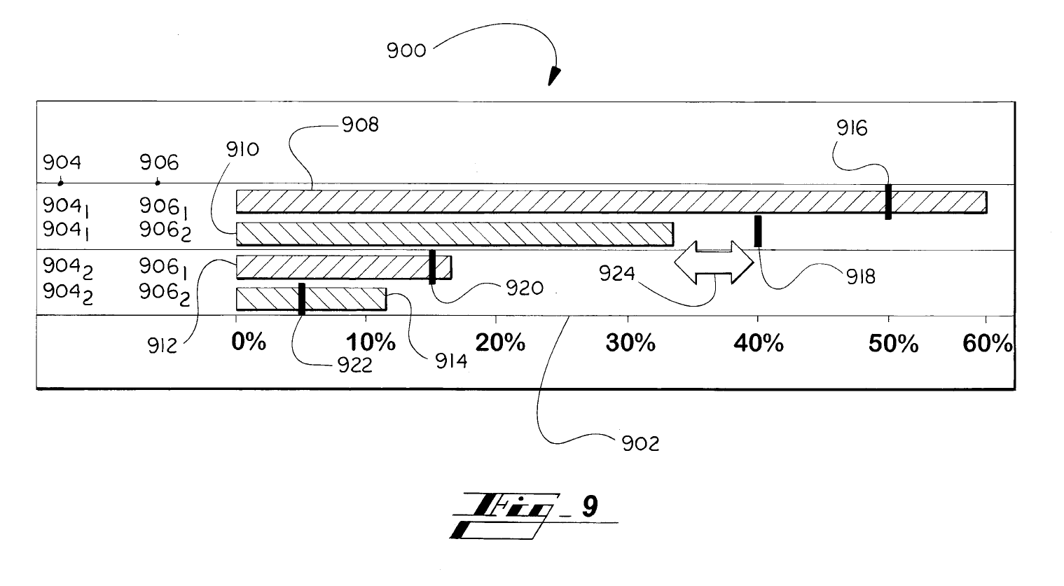

FIGS. 8 and 9

FIG. 8 illustrates methods for evaluating sales loyalty of a subject dealer and comparing one or more dealers based on actual sales loyalty performance and benchmarks. FIG. 9 illustrates an example sales-loyalty chart indicating actual performance levels and corresponding benchmarks for a dealer, in connection with four performance segments.

The process 800 of FIG. 8 is in various embodiments performed by a hardware-based system (including, for instance, a processing device), such as that of an automotive dealership, manufacturer, or other service provider.

The process 800 begins 802 and flow proceeds to operation 804 whereat the system obtains data indicating actual sales loyalty performance of a dealer in connection with each of the sales-geographic-loyalty segments (e.g., a, b, c, d). The data can be obtained in any of a variety of ways, including receiving the data or generating the data.

FIG. 9 shows example actual sales loyalty levels 908, 910, 912, 914. As described above, the chart 900 shows sales-loyalty levels, by way of example, in terms of percentages marked on the x-axis 902. The data bars 908, 910, 912, 914 can be equated to the loyalty segments as follows:

| Reference Numeral | Segments |
|---|---|
| 908 | a |
| 910 | c |
| 912 | b |
| 914 | d |

Continuing with FIG. 8, the system at operation 806 obtains benchmark sales loyalty (BSL) levels for use in evaluating at least one subject dealer. The data can be obtained in any of a variety of ways, including receiving or generating the data.

Corresponding benchmark sales loyalty (BSL) values for these segments are indicated by reference numerals 916, 918, 920, 922 in FIG. 9. The BSL levels 916, 918, 920, 922 are in some embodiments the same for each dealer being evaluated. In other embodiments, the benchmarks 916, 918, 920, 922 are calculated separately for each dealer being evaluated.

For embodiments of the method 800 in which a single dealer is being evaluated, flow proceeds to operation 808 whereat the system determines a segment, of segments a, b, c, d, in which the dealer performed the worst. The operation in one embodiment involves determining in which segment the difference between ASL is the farthest from a higher BSL. In the example of FIG. 9, the largest difference 924 separates the second data bar 910 and the corresponding benchmark 918.

If ASL is higher than BSL in each category, the dealership is deemed to be performing very well. The segment of weakest performance can still be determined as the segment in which the ASL is closest to the benchmark in this case. And an output object can still be generated and shared with the well-performing dealer for use in dealer improvement efforts.

At operation 810, the system generates, and in some cases, communicates, an output object such as a recommendation for action to improve sales loyalty performance for the dealer. The output object is communicated in any one or more of a variety of ways. Information corresponding to the output object can be displayed on a screen, communicated electronically, and/or printed. The object in some embodiments comprises actionable computer code, which when executed, causes the system to perform improvement activity, such as initiating one or more actions toward improving sales-loyalty performance in the weakest segment identified. The results, or output objects can, as mentioned, be reported in a variety of ways. The object(s) may be reported by a formal reported provided in electronic format or hardcopy. The object or report containing the object can be transmitted electronically, such as by email or website, for instance. In some embodiment, the output object is executable by a receiving computer system to (1) perform, based on the object, an action toward improving sales-performance of the recipient organization, or (2) improve evaluation of one or more dealers based on the object. In a contemplated embodiment the output object includes a link to a source comprising code to be executed for one of these two (2) purposes.

In a contemplated embodiment, the output object references more than one segment in which sales-loyalty performance can or should be improved by the dealer. The object can refer, for instance, to a difference between the ASL and the BSL for two or more segments, for instance, and ways to shorten and/or overtake the difference. The manners can include one or more controllable factors, and how to change them.

As an example, if at operation 810 the system determines that an investment in customer service would be a most-effective investment to improve sales-loyalty level in a particular segment for a subject dealer, the object can include suggested actions that the dealer can take to improve customer service, such as upgrading a communication (e.g., phone) system, increasing hours, and/or increasing or improving personnel training.

Generation, communication, and content of the output object can be similar or the same as described above regarding output objects.

The process 800, or any portions thereof, is repeated, as indicated generally by path 812, or end 814.

For embodiments in which the method 800 includes comparing dealers, such as a pairwise comparison of two automotive dealerships, operations 804 and 806 are performed for each of the dealers being compared, and flow proceeds to operation 816.

At operation 816, the system compares the dealers in one or more ways. In one implementation, the system determines a best-performing and worst-performing dealer in each segment (e.g., a, b, c, d) by determining which dealer's ASL is closest to (if below) or farthest above (if above) its BSL in the segment.

In another implementation, the system determines an overall best-performing and/or worst-performing dealer, such as by averaging for each dealer the amounts by which the dealer ASL is above/below the BSL in the segments.

A dealer can be best in on segment while being worst and needing work in another segment. Various dealers can receive output objects tailored to their respective situations. This can be the case, in embodiments, no matter how well the dealer is performing in each segment.

At operation 818, the system generates, and in some cases communicates, an output object. The object can be like any of those described above, for any of the dealers being evaluated, and in connection with any or all subject sales-loyalty performance segments, and is not described further here.

The process 800 or any portions thereof can be repeated, or the process can end 814.

### Select Benefits of the Present Technology and Conclusion

Select Benefits

Many of the benefits and advantages of the present technology are described above. The present section restates some of those benefits and references some others. The benefits are provided by way of example, and are not exhaustive of the benefits of the present technology.

The technology allows more accurate measures of dealer sales effectiveness. The technology incorporates geographic and prior-sales relationships on sales loyalty. Resulting dealer analyses and dealer-to-dealer comparisons using the present technologies are more accurate than conventional techniques.

By using prior-sales and geographic considerations, together, determining effectiveness of dealers is less biased by factors such as changes in the dealer network. While a first dealer may have relatively low sales in a given period of time, for instance, it may be determined that the reason relates to a new dealer being added in their area or in an adjacent area. Losing some sales to the new dealer is natural and should not count against evaluation of the first dealer. Such anomalies are accommodated at least partially by the approach of evaluating dealers based, not just on raw sales figures but rather, on multiple sales-and-geographic loyalty figures.

Also, by using more accurate metrics and/or comparisons, truly high-performing dealers can be identified and rewarded or incentivized. A dealer having a higher aggregate prior-sales loyalty and geographic sales number (e.g., pump-in and pump-out numbers) performed better than a dealer having a higher raw sales number but a lower aggregate number for the subject time period. The present technology enables identification and rewarding of such higher performance.

Moreover, using output objects, such as determined performance metrics or recommended actions based on such metrics, dealers can determine ways to improve their sales performance.

The technology in some implementations includes providing actionable dealer improvement objects comprising data for use in prioritizing dealer improvement efforts.

As another benefit of the present technology, the data created in the process described, being at a novel level of high granularity, can be put to various advantageous uses. The increased granularity of information (e.g., pump-in, pump-out, and related metrics) provides dealers and managing organizations or individuals reviewing dealers, with more, and more-actionable, guidance. As an example, a dealer having an output object including more granular, sales-and-geographic-loyalty data, can more accurately target new advertising efforts. Or a dealer system receiving an output object comprising a specific recommendation regarding dealer service hours of operation will determine easily exactly how to adjust hours of the dealer to improve in a subject segment.

As other examples, dealer or manager systems can easily determine based on output objects how to improve sales by modifying customer service, such as by training, dress code, and protocols for phone and in-person customer interactions, advertising, and inventory make-up, mix, or size.

### CONCLUSION

Various embodiments of the present disclosure are disclosed herein. The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

1. A system, comprising:
a processing hardware unit; and
a non-transitory storage device comprising a plurality of modules configured to perform various operations;
an obtain module, of the plurality of modules, configured to cause the processing hardware unit to obtain, regarding a pair of dealers, including a first dealer (X) and a second dealer (Y), prior-sale-and-geographic loyalty data comprising:
a first-dealer geography-based loyalty number (L_{YXX}) representing a number of customers who (i) purchased a prior vehicle from the second dealer, while (ii) residing in a first-dealer area, associated with the first dealer, and (iii) purchased a subsequent vehicle from the first dealer;
a second-dealer prior-sale-based loyalty number (L_{YXY}) representing a number of customers who (i) purchased a prior vehicle from the second dealer, while (ii) residing in the first-dealer area, and (iii) purchased a subsequent vehicle from the second dealer;
a second-dealer geography-based loyalty number (L_{XYY}) representing a number of customers who (i) purchased a prior vehicle from the first dealer, while (ii) residing in a second-dealer area, associated with the second dealer, and (iii) purchased a subsequent vehicle from the second dealer; and
a first-dealer prior-sale-based loyalty number (L_{XYX}) representing a number of customers who (i) purchased a prior vehicle from the first dealer, while (ii) residing in the second-dealer area, and (iii) purchased a subsequent vehicle from the first dealer; and
a determine module, of the plurality of modules, configured to cause the processing hardware unit to determine, based on the prior-sale-and-geographic loyalty data, that the second dealer performed worse in terms of prior-sale-and-geographic loyalty performance;
a generate module, of the plurality of modules, configured to cause the processing hardware unit to generate, in response to determining that the second dealer performed worse, a performance-improvement object configured to initiate an action by the second dealer to improve sales-and-geographic loyalty performance for the second dealer; and
a transmit module, of the plurality of modules, configured to cause the processing hardware unit to transmit the performance-improvement object to a receiving device for use in improving the sales-and-geographic loyalty performance of the second dealer.

2. The system of claim 1, wherein the receiving device is a component of a system of the second dealer.

3. The system of claim 1, wherein the performance-improvement object indicates a performance-improvement action that the second dealer can take to improve sales-and-geographic loyalty performance.

4. The system of claim 1, wherein:
the determine module is a first determine module;
the system further comprises a second determine module, of the plurality of modules, configured to cause the processing hardware unit to determine a controllable factor causing, more than other controllable factors, the second dealer to perform poorly compared to the first dealer; and
the performance-improvement object indicates the controllable factor determined.

5. The system of claim 1, wherein:
the generate module is a first generate module; and
the system further comprises a second generate module, of the plurality of modules, configured to cause the processing hardware unit to generate a first dealer first dealer-pump-in sales loyalty (PIL_{X}), associated with the first dealer, a second pump-in loyalty factor (PIL_{Y}), associated with the second dealer, a first pump-in loyalty factor (POL_{X}), associated with the first dealer, a second pump-out loyalty (POL_{Y}), associated with the second dealer, wherein:
PIL_{X}=L_{YXX}/(L_{YXX}+L_{YXY});
PIL_{Y}=L_{XYY}/(L_{XYY}+L_{XYX});
POL_{X}=L_{XYX}/(L_{XYX}+L_{XYY}); and
POL_{Y}=L_{YXY}/(L_{YXY}+L_{YXX}).

6. The system of claim 5, further comprising a third generate module, of the plurality of modules, configured to cause the processing hardware unit to generate a comparative sales-and-geographic loyalty result based on the first and second pump-in loyalty factors (PIL_{X}), (PIL_{Y}) and the first and second pump-in loyalty (POL_{X}), (POL_{Y}).

7. The system of claim 6, wherein the third module, in being configured to cause the processor to generate the comparative sales-and-geographic loyalty result, causes the processing hardware unit to determine a first-dealer indexed total sales loyalty metric (TSL_{X}) and a second-dealer indexed total sales loyalty metric (TSL_{Y}) dealer;
TSL_{X}=PIL_{X}+POL_{X}; and
TSL_{Y}=PIL_{Y}+POL_{Y}.

8. The system of claim 7, wherein the third module, in being configured to cause the processor to generate the comparative sales-and-geographic loyalty result, causes the processing hardware unit to determine, with a relatively modest degree of confidence, if TSL_{X}>TSL_{Y}, the conclusion that the second dealer performed worse than the first dealer in terms of prior-sale-and-geographic loyalty performance.

9. The system of claim 8, wherein the third module, in being configured to cause the processor to generate the comparative sales-and-geographic loyalty result, causes the processing hardware unit to determine, with a relatively high degree of confidence, if PIL_{X}>PIL_{Y} and POL_{X}>POL_{Y}, that the second dealer performed worse than the first dealer in terms of prior-sale-and-geographic loyalty performance.

10. The system of claim 6, wherein the third module, in being configured to cause the processor to generate the comparative sales-and-geographic loyalty result, causes the processing hardware unit to determine, with a relatively high degree of confidence, if PIL_{X}>PIL_{Y} and POL_{X}>POL_{Y}, that the second dealer performed worse than the first dealer in terms of prior-sale-and-geographic loyalty performance.

11. The system of claim 6, wherein:
the first module, in being configured to cause the processing hardware unit to generate the performance-improvement object for the second dealer, is configured to cause the processing hardware unit to determine in which of multiple prior-sales-geography-based segments the second dealer performed worse with respect to a pre-established benchmark; and
the performance-improvement object indicates a most-room-to-improve category.

12. A non-transitory storage device comprising a plurality of modules configured to perform various operations, the modules comprising:
an obtain module, of the plurality of modules, configured to cause a processing hardware unit to obtain, regarding a pair of dealers, including a first dealer (X) and a second dealer (Y), prior-sale-and-geographic loyalty data comprising:
a first-dealer geography-based loyalty number (L_{YXX}) representing a number of customers who (i) purchased a prior vehicle from the second dealer, while (ii) residing in a first-dealer area, associated with the first dealer, and (iii) purchased a subsequent vehicle from the first dealer;
a second-dealer prior-sale-based loyalty number (L_{YXY}) representing a number of customers who (i) purchased a prior vehicle from the second dealer, while (ii) residing in the first-dealer area, and (iii) purchased a subsequent vehicle from the second dealer;
a second-dealer geography-based loyalty number (L_{XYY}) representing a number of customers who (i) purchased a prior vehicle from the first dealer, while (ii) residing in a second-dealer area, associated with the second dealer, and (iii) purchased a subsequent vehicle from the second dealer; and
a first-dealer prior-sale-based loyalty number (L_{XYX}) representing a number of customers who (i) purchased a prior vehicle from the first dealer, while (ii) residing in the second-dealer area, and (iii) purchased a subsequent vehicle from the first dealer; and
a determine module, of the plurality of modules, configured to cause the processing hardware unit to determine, based on the prior-sale-and-geographic loyalty data, that the second dealer performed worse in terms of prior-sale-and-geographic loyalty performance;
a generate module, of the plurality of modules, configured to cause the processing hardware unit to generate, in response to determining that the second dealer performed worse, a performance-improvement object configured to initiate an action by the second dealer to improve sales-and-geographic loyalty performance for the second dealer; and
a transmit module, of the plurality of modules, configured to cause the processing hardware unit to transmit the performance-improvement object to a receiving device for use in improving the sales-and-geographic loyalty performance of the second dealer.

13. The non-transitory storage device of claim 12, wherein the performance-improvement object indicates a performance-improvement action that the second dealer can take to improve sales-and-geographic loyalty performance.

14. The non-transitory storage device of claim 12, wherein:
the determine module is a first determine module;
the system further comprises a second determine module, of the plurality of modules, configured to cause the processing hardware unit to determine a controllable factor causing, more than other controllable factors, the second dealer to perform poorly compared to the first dealer; and
the performance-improvement object indicates the controllable factor determined.

15. The non-transitory storage device of claim 12, wherein:
the generate module is a first generate module; and
the system further comprises a second generate module, of the plurality of modules, configured to cause the processing hardware unit to generate a first dealer first dealer-pump-in sales loyalty (PIL_{X}), associated with the first dealer, a second pump-in loyalty factor (PIL_{Y}), associated with the second dealer, a first pump-in loyalty factor (POL_{X}), associated with the first dealer, a second pump-out loyalty (POL_{Y}), associated with the second dealer, wherein:
PIL_{X}=L_{YXX}/(L_{YXX}+L_{YXY});
PIL_{Y}=L_{XYY}/(L_{XYY}+L_{XYX});
POL_{X}=L_{XYX}/(L_{XYX}+L_{XYY}); and
POL_{Y}=L_{YXY}/(L_{YXY}+L_{YXX}).

16. The non-transitory storage device of claim 15, wherein a third generate module, of the plurality of modules, configured to cause the processing hardware unit to generate a comparative sales-and-geographic loyalty result based on the first and second pump-in loyalty factors (PIL_{X}), (PIL_{Y}) and the first and second pump-in loyalty (POL_{X}), (POL_{Y}).

17. The non-transitory storage device of claim 16:
the first module, in being configured to cause the processing hardware unit to generate the performance-improvement object for the second dealer, is configured to cause the processing hardware unit to determine in which of multiple prior-sales-geography-based segments the second dealer performed worse with respect to a pre-established benchmark; and
the performance-improvement object indicates a most-room-to-improve category.

18. A method, comprising:
obtaining, by a processor executing an obtain module of a non-transitory storage device, regarding a pair of dealers, including a first dealer (X) and a second dealer (Y), prior-sale-and-geographic loyalty data comprising:
a first-dealer geography-based loyalty number (L_{YXX}) representing a number of customers who (i) purchased a prior vehicle from the second dealer, while (ii) residing in a first-dealer area, associated with the first dealer, and (iii) purchased a subsequent vehicle from the first dealer;
a second-dealer prior-sale-based loyalty number (L_{YXY}) representing a number of customers who (i) purchased a prior vehicle from the second dealer, while (ii) residing in the first-dealer area, and (iii) purchased a subsequent vehicle from the second dealer;
a second-dealer geography-based loyalty number (L_{XYY}) representing a number of customers who (i) purchased a prior vehicle from the first dealer, while (ii) residing in a second-dealer area, associated with the second dealer, and (iii) purchased a subsequent vehicle from the second dealer; and
a first-dealer prior-sale-based loyalty number (L_{XYX}) representing a number of customers who (i) purchased a prior vehicle from the first dealer, while (ii) residing in the second-dealer area, and (iii) purchased a subsequent vehicle from the first dealer; and
determining, by the processor executing a determine module of the non-transitory storage device, based on the prior-sale-and-geographic loyalty data, that the second dealer performed worse in terms of prior-sale-and-geographic loyalty performance;
generating, by the processor executing a generate module of a non-transitory storage device, in response to determining that the second dealer performed worse, a performance-improvement object configured to initiate an action by the second dealer to improve sales-and-geographic loyalty performance for the second dealer; and
transmitting, by the processor executing a transmit module of a non-transitory storage device, the performance-improvement object to a receiving device for use in improving the sales-and-geographic loyalty performance of the second dealer.

19. The method of claim 18, wherein the performance-improvement object indicates a performance-improvement action that the second dealer can take to improve sales-and-geographic loyalty performance.

20. The method of claim 18, wherein:
the determine module is a first determine module;
the method further comprises determining, by the processing hardware unit executing a second determine module, a controllable factor causing, more than other controllable factors, the second dealer to perform poorly compared to the first dealer; and
the performance-improvement object indicates the controllable factor determined.
